(19) United States
(12) Patent Application Publication
(10) Pub. No.: US 2025/0190290 A1
(43) Pub. Date: Jun. 12, 2025

(54) GENERATIVE ARTIFICIAL INTELLIGENCE USING A SERVER SIDE PROMPT PROGRAM

(71) Applicant: Crystal Computing Corp., Dover, DE (US)

(72) Inventor: Cole L. Kissane, Palo Alto, CA (US)

(21) Appl. No.: 18/939,214

(22) Filed: Nov. 6, 2024

Related U.S. Application Data
(60) Provisional application No. 63/609,286, filed on Dec. 12, 2023.

(51) Int. Cl. G06F 9/54

(52) U.S. Cl. CPC G06F 9/547

(57) ABSTRACT

Generative artificial intelligence (AI) using a server-side prompt program is disclosed. In various embodiments, an API call comprising a request is received from a remote system. A server-side prompt program comprising or otherwise associated with one or both of the API call and the request is executed, including by sending two or more prompts to a generative AI service. A final result obtained by sending the two or more prompts to the generative AI service is received and returned to the remote system in response to the API call.

### CROSS REFERENCE TO OTHER APPLICATIONS

This application claims priority to U.S. Provisional Patent Application No. 63/609,286 entitled GENERATIVE ARTIFICIAL INTELLIGENCE USING A SERVER SIDE PROMPT PROGRAM filed Dec. 12, 2023 which is incorporated herein by reference for all purposes.

### BACKGROUND OF THE INVENTION

Generative artificial intelligence systems using large language models trained on a corpus of data have been used to generate reasonably compelling text and other content (e.g., images) in response to input prompts. The nature, quality, and usefulness of AI-generated content may be determined to a significant extent by the prompt(s) provided to the generative AI system to create the content. The field of “prompt engineering” has emerged to formalize the study and practice of techniques to construct prompts and sequences of prompts to best use generative AI to create desired content.

Typically, a developer of an application to be used to perform a more complicated task-such as planning the itinerary for a trip to Europe-might have to include code to make successive API or other calls to a generative AI system, e.g., to present a sequence of prompts one or more of which may depend at least in part on a result provided in a response to an earlier prompt in the sequence. In such an approach, each prompt requires a network call to the generative AI system, with attendant delays and resource consumption.

### BRIEF DESCRIPTION OF THE DRA WINGS

Various embodiments of the invention are disclosed in the following detailed description and the accompanying drawings.

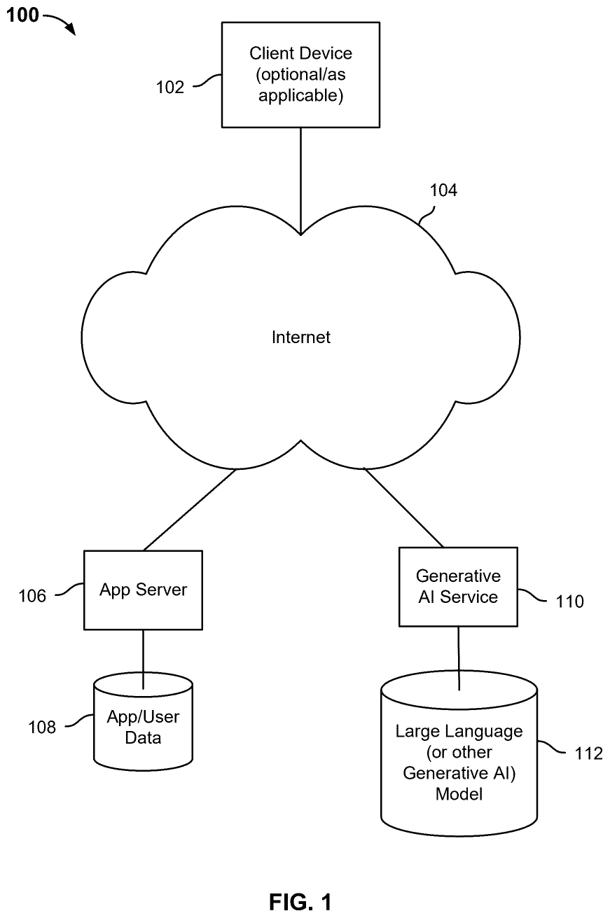

FIG. 1 illustrates an embodiment of a system and environment in which a generative AI server-side prompt program, or other code, is used to submit a sequence of prompts to a generative AI system.

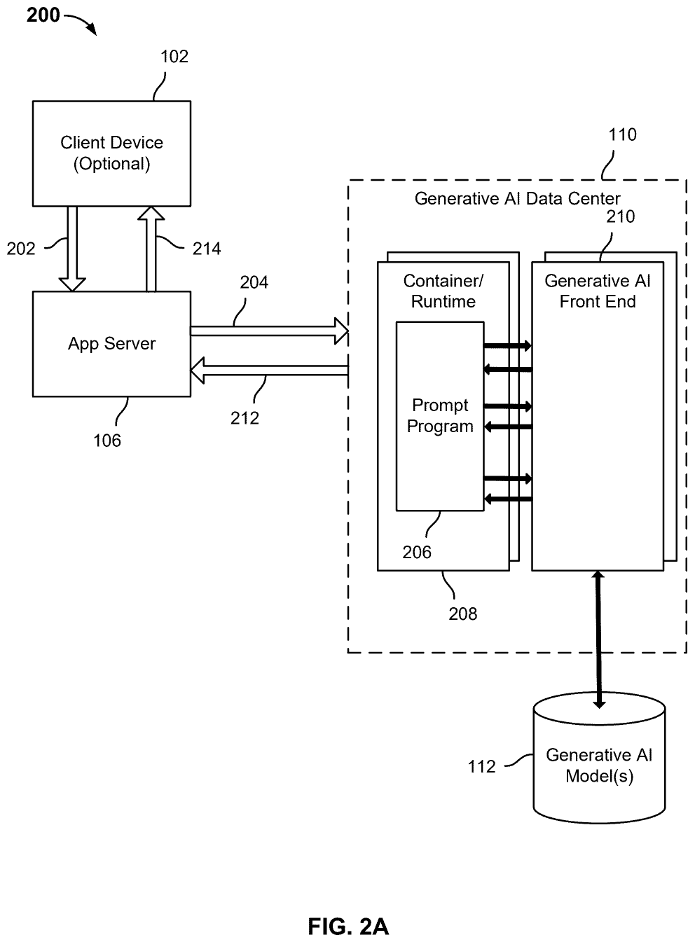

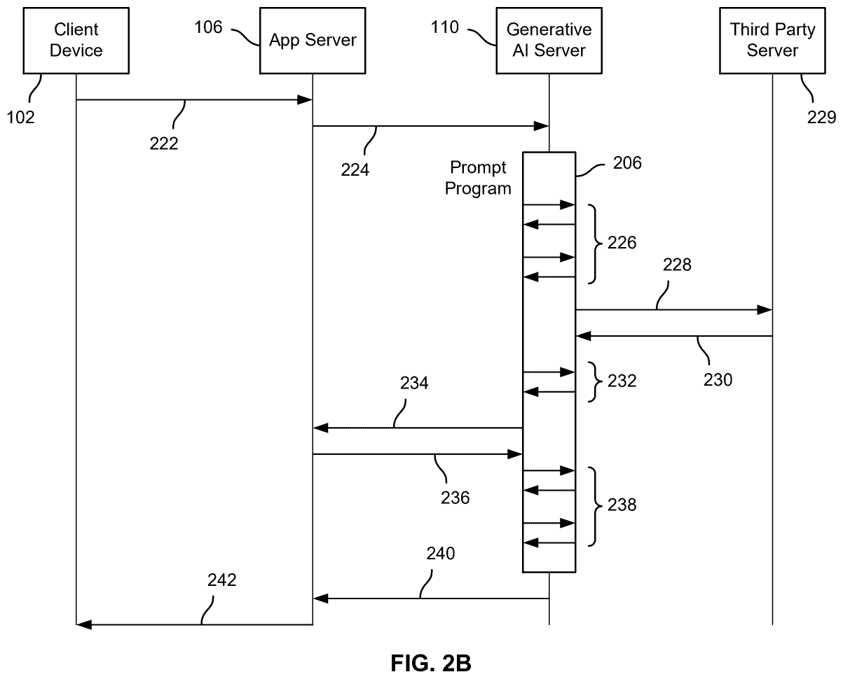

FIG. 2A is a functional block diagram illustrating an embodiment of a system in which generative AI server-side prompt programs, or other code, is used to submit a sequence of prompts to a generative AI system.

FIG. 2B is a call sequence diagram illustrating an example of a prompt program configured to make or cause the generative AI service to make a call to a third-party server or the application server.

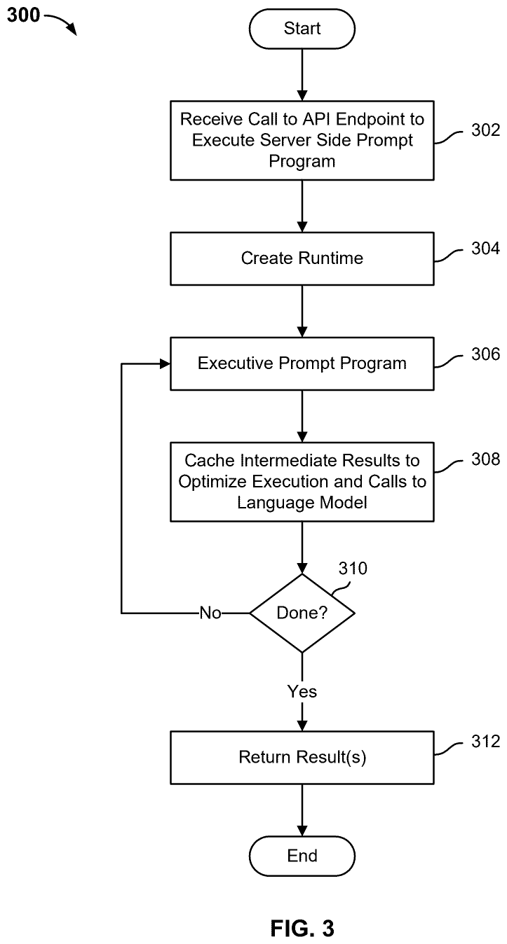

FIG. 3 is a flow diagram illustrating an embodiment of a process to use generative AI server-side prompt programs, or other code, to submit a sequence of prompts to a generative AI system.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Techniques are disclosed to enable an application to cause a generative AI system to process and respond to a sequence of prompts without requiring each prompt to be sent separately and serially to the generative AI system. In some embodiments, the application makes a single API or other call to the generative AI system. The call includes and/or invokes a “prompt program”, comprising a script or other executable code, which is executed at the generative AI system. The prompt program does one or more of the following: presents a series of prompts, receives and processes intermediate results, receives a result generated in response to the final prompt provided by the prompt program, and returns a final result to the application and/or application user.

In various embodiments, a prompt program as disclosed herein achieves an application-level goal at least in part by presenting a sequence of prompts to a generative AI server. In some cases, prompts later in the sequence may be determined at least in part by the content returned by the generative AI system in response to an earlier prompt and/or data retrieved from a remote system using content returned by the generative AI system in response to an earlier prompt. For example, a prompt program may include a conditional or other fork, with the path for subsequent prompts being determined based on generative AI content returned in response to an earlier prompt or based on input from an application or application user, data retrieved from a third-party server, etc.

FIG. 1 illustrates an embodiment of a system and environment in which a generative AI server-side prompt program, or other code, is used to submit a sequence of prompts to a generative AI system. In the example shown, system and environment 100 (optionally) includes a client device 102 connected via the Internet 104 to an application server 106. In various embodiments, application server 106 uses application/user data 108 to provide access to an application to a user of client device 102, as well as other users of other client devices. In some embodiments, application server 106 runs an application that does not (necessarily) require or interact with a client device. In various embodiments, application server 106 may be configured to make an API or other call to a generative AI service 110, which uses a large language model 112 (or other generative AI model, such as a generative AI image model) to generate and return a response to application server 106. In some embodiments, the AI service 110 is configured to select from a plurality of generative AI models 112 one or more models to be used to respond to prompts received from a given prompt program.

In various embodiments, the application server 106 makes an API call to an API endpoint of generative AI service 110. The API call includes a payload that the API endpoint is configured to receive and process at least in part by executing at the generative AI service a prompt program or other code configured to present a sequence or other set of prompts to the generative AI service, without requiring further API calls from the application server 106. In some embodiments, the prompt program may make or initiate the making of one or more intermediate calls to a third-party server, e.g., to obtain information needed for a next phase of execution or processing by the prompt program, and/or back to application server 106, e.g., to obtain user input based on an intermediate result. A final result, returned by the generative AI server in response to a final prompt comprising and/or associated with the prompt program, is returned to the application server 106 as a response to the API call.

In some embodiments, the prompt program is provided by application server 106 via the API call. In some embodiments, the API call includes an identifier associated with the prompt program and one or more variables to be provided to the prompt program as arguments or inputs, but the prompt program code resides at the generative AI service 110. For example, a developer or administrator of the application with which application server 106 is associated may have uploaded or otherwise provided the prompt program to the generative AI service 110, prior to the time the API call was made. The API call may include an identifier that identifies the prompt program to be executed, or the prompt program may be determined by the generative AI service, e.g., based on the application or server from which the API call was received, the structure or content of variables or other data comprising or associated with the API call, the endpoint to which the API call was sent, etc.

In some embodiments, the generative AI server 110 is configured to optimize execution of a prompt program, e.g., in a manner similar to a compiler. The AI server 110 may inspect the code comprising the prompt program and do one or more of the following: change the order of execution of instructions comprising the code; execute two or more portions of the prompt program in parallel; replace a prompt included in the prompt program with a prompt more likely to result in desired and/or more usable results being returned; etc.

In some embodiments, the prompt program is expressed in a scripting language or other interpreted language, such as Python. In some embodiments, the prompt program is created using a domain specific language constructed to facilitate server-side orchestration of a creative or other generative process. A prompt program written in the domain specific language may present a sequence of prompts to a generative AI service, and may include code to perform other orchestration tasks, such as assembling AI generated content into a desired form, such as a scrapbook in which photos are selected, cropped, arranged in timeline order, laid out pages, and captioned using generative AI. In various embodiments, the prompt program may make calls out to a third-party server, e.g., a photo sharing, storage, or management site or service, and/or back to the application server that made the API call to cause the prompt program to run on or near the generative AI server.

In some embodiments, a prompt program may include or may authorize or facilitate use of a third-party account of an application end user for whose benefit the prompt program has been sent to the generative AI service. For example, a credential to access the user's photos or other information as stored on the third-party site may be included or invoked. In some embodiments, an API token, private key, or other encryption key may be provided, to enable encrypted data retrieved by the prompt program to be decrypted.

In another example, a system as disclosed herein may be used to quickly and efficiently schedule a meeting with attendees who satisfy a specified set of criteria. For example, a request may be sent to an API endpoint associated with a server-side prompt program to schedule a meeting. For example, a Sales Manager may send to an API endpoint of a generative AI system a request that a meeting be scheduled with all Sales Representatives in the Western Region who work for the requesting Sales Manager and have had contact with Company XYZ in the last thirty (30) days. In various embodiments, a server-side prompt program may be included in or with the request, already be present at the server and associated with the API endpoint, or already be present at the server and mapped to the request based on an identifier in the request, the format and/or content of the request, etc.

Continuing the example, the server-side prompt program may perform one or more of the following:
Send a prompt to the generative AI service (e.g., LLM front end) to generate a properly-formatted request to the enterprise directory service of the Sales Manager's company to obtain the directory records of all persons with the “Sale Representative” role assigned to the “Western Region”
Receive the request and send it to the enterprise directory service.
Receive a set of records from the enterprise directory service in response to the request.
Include the records in a prompt to the generative AI service to identify the Sales Representatives who report to the Sales Manager and are in the Western Region.
Use the response to send a prompt to the generative AI service to construct a query a third-party customer relationship management (CRM) service associated with the Sales Manager's enterprise to determine which of the Western Region Sales Representatives who report to the Sales Manager have logged a contact with Company XYZ in the last thirty (30) days.
Send the query to the CRM service and receive a response.
Use the response to determine which Sales Representatives should be included in the meeting.
Prompt the generative AI service to construct a query to determine the calendar availability of the Sales Manager and the Sale Representatives to be included in the meeting.
Use the calendar availability data to select a time/date for the meeting.
Prompt the generative AI service to construct a communication to place the meeting on the participants' respective calendars and send the response to the enterprise calendar service to schedule the meeting.
Use the calendar availability data of the Sales Manager as a required attendee and the calendars of the Sales Representatives to select a set of candidate dates and sites for a three day offsite during the working week within the Western Region.
Based on the output regarding each of the candidate attendees and the dates and sites, utilize branch logic comprising the prompt program to create new prompts depending on
the attendee's home address and the intended gathering site to generate for each attendee, e.g.:
   (1) a prompt to the generative AI service to construct an API call to check local transportation options for attendees that would be already in the vicinity of the respective candidate site and thus would not reasonably require airline transportation; OR
   (2) a prompt to the generative AI service to construct an API call to check a third-party Travel Service to ascertain the pricing and airfare availability for candidate participants originating outside the vicinity.
Based on the above outputs on candidate attendees, destinations, and dates, send yet another prompt to the generative AI service to construct another API call to check another third-party travel API to determine best candidate hotel sites based on ratings, pricing, and availability during the dates to host this size gathering.
Based on the participants, sites, availability, local transportation, air options, and hotel options, prompt the generative AI to select the three best combinations of participants, sites, dates, local travel, air travel, and hotels and create a ranked order priority list of the three rough draft offsites along with their constituent elements.
Based on the list, send a prompt the generative AI service to construct an appropriate set of communications to place a hold for the three candidate offsites on participating team member calendars, including in the calendar information for each their respective listed composite participants, dates, local travel, air travel, and hotels.
Prompt the generative AI service to construct a well formatted response suitable for email conveyance in response to the original API call that includes the time and date of the meeting and the information including the attendees, their role, a summary of their contacts with the company XYZ that each had in the last 30 days, their home city, the ability for them to attend each of the three candidate final candidate offsites, as well as a summary of all the attendees, their proposed local travel or flights, the proposed hotels, and the estimated costs.
Prompt the generative AI service to construct a response to the original API call that includes some/all of the information described above, e.g., the time/date of the meeting and information such as the list of attendees, a summary of the contact(s) with Company XYZ that each has had in the last thirty (30) days, etc.
Send the response to the system/user from which the original API call was received.

In various embodiments, a system as disclosed herein may exhibit, provide, and/or support one or more of the behaviors and features described above, including all or fewer than all, and/or may provide or support myriad other features, requirements, or scenarios, e.g., any sequence or scenario that may be conceived and embodied in a server-side prompt program, including conditional (e.g., branch) logic as described above.

As the above example and variations illustrate, in various embodiments, a system as disclosed herein enables a complicated sequence of calls and processing steps to be completed, and a useful and complete result obtained, all by making a single API call to the generative AI server.

FIG. 2A is a functional block diagram illustrating an embodiment of a system in which generative AI server-side prompt programs, or other code, is used to submit a sequence of prompts to a generative AI system. In the example shown, system 200 includes (optionally) client device 102, application server 106, generative AI service 110, and large language model 112 of FIG. 1. Client device 102 is shown to send an application-related request 202 to application server 106. To respond to the request, application server 106 makes an API call 204 to a generative AI service (API endpoint) associated with generative AI data center 110. In some embodiments, the application server 106 may initiate the API call 204 without requiring or receiving input from any client device. The API call 204 is made to an endpoint associated with execution of a prompt program at the generative AI data center 110, as disclosed herein.

In response to the API call 204, generative AI server 110 runs prompt program 206 in a virtual machine, container, or other runtime environment 208. In some embodiments, code comprising or associated with prompt program 206 is provided via API call 204. In some embodiments, prompt program 206 resides at generative AI server 110 prior to API call 204 being received, and API call 204 includes data that is used by generative AI server 110 to identify and run prompt program 206.

Generative AI data center 110 may include a plurality of servers. For example, prompt program 206 may execute in container/runtime 208 running on a first server, while other prompt programs may be executing in other runtimes on one or more other servers.

Prompt program 206 includes code configured to submit a sequence of prompts to generative AI front end 210, which uses large language model 112 to provide a response to each prompt. Prompt program 206 may include code configured to receive and process a response received to a first prompt to form and/or complete a later prompt in the sequence.

In some embodiments, generative AI server 110 may cache the result returned to each prompt received from the prompt program 206, which in some cases may enable the generative AI server 110 to reply more quickly or efficiently to a later prompt received from prompt program 206. In some embodiments, the generative AI server 110 may inspect the prompt program 206 and may prefetch a response and/or prepare to receive and respond to a prompt prior to the prompt being presented by prompt program 206.

Once the prompt program 206 has finished running, a final generative AI result provided in response to a final prompt in the sequence of prompts presented by the prompt program 206 or, in some embodiments, a final result or set of results determined by prompt program 206 based on the responses received to the prompts presented by the prompt program 206, is returned to the application server 106 via a results communication 212. The application server 106 in turn sends a results page/date 214 to the client device 102.

FIG. 2B is a call sequence diagram illustrating an example of a prompt program configured to make or cause the generative AI service to make a call to a third-party server or the application server. In various embodiments, a prompt program as disclosed herein may include code to make a call to a third-party service, e.g., to obtain data needed to continue to or complete the next phase of execution. For example, a prompt program may be configured to prompt the generative AI system to provide a list of travel destinations in a particular country or region, and may include code to obtain information about the destinations returned by the generative AI system in response to the prompt, e.g., weather information, hotel availability, etc.

In the example shown in FIG. 2B, client device 102 sends an application-level request 222 to application server 106. Application server 106 in turn sends a prompt program 206 and an associated API call 224 to generative AI server 110. Generative AI server 110 executes the prompt program 206, e.g., in an associated runtime. In this example, prompt program 206 sends a sequence of prompts 226 to and receives associated responses from the generative AI service. As prompt program 206 continues to execute (or during a pause or interrupt in its execution), prompt program 206 sends (or causes the generative AI server 110 to send) a request 228 to third party server 229, which returns a response 230. For example, the request 228 might request information about the weather in a travel destination identified via the prompts/responses 226.

In the example shown in FIG. 2B, the information 230 obtained from third party server 229 is used by the prompt program 206 to perform further processing, e.g., prompt/response 232 to/from the generative AI server 110. In this example, a callback 234 is then sent to the application server 106, for example to obtain user data, a result of application server logic operating on intermediate generative AI results, solicit user input via a user interface or other page displayed by application server 106, etc. A response 236 is sent from application server 106 to generative AI server 110 and/or prompt program 206. A further set 238 of prompts and responses are exchanged prior to a final result 240 being sent to application server 106 and (optional) an application response 242 being sent to the client device 102 (if any).

FIG. 3 is a flow diagram illustrating an embodiment of a process to use generative AI server-side prompt programs, or other code, to submit a sequence of prompts to a generative AI system. In various embodiments, process 300 of FIG. 3 may be implemented by a generative AI system, such as generative AI server 110 of FIGS. 1 and 2. In the example shown, at 302 an API call is received at an API endpoint configured to receive and execute a generative AI server-side prompt program or other code, as disclosed herein. At 304, a virtual machine, container, and/or runtime are created to run the prompt program. At 306, the prompt program code is executed. At 308, intermediate results to prompts presented by the prompt program may be cached. For example, the generative AI server may use the cached results to make, modify, transform, and/or optimize calls made to the large language model in response to prompts subsequently received from the prompt program.

In various embodiments, intermediate results may be cached for as long as the prompt program is running. Previously, such results typically would not be cached, and may have to be regenerated or regenerated in part in response to a further/subsequent prompt. For example, the application server may have to send a subsequent prompt that includes at least a portion of the results returned in response to an earlier prompt, requiring resources to be consumed to maintain state information at the application server, send the same content back and forth between the application server and the generative AI server, and (re) generate the same content multiple times at the generative AI server.

At 310, a determination is made as to whether execution of the prompt program is done. If so, the process 300 ends; if not, the prompt program continues to be executed at 306.

In various embodiments, techniques disclosed herein may be used to obtain through a single API call a generative AI result that previously may have required multiple API calls.

Although the foregoing embodiments have been described in some detail for purposes of clarity of understanding, the invention is not limited to the details provided. There are many alternative ways of implementing the invention. The disclosed embodiments are illustrative and not restrictive.

1. A generative artificial intelligence (AI) system, comprising:
a communication interface configured to receive from a remote system an API call comprising a request; and
a processor coupled to the communication interface and configured to:
execute a server-side prompt program comprising or otherwise associated with one or both of the API call and the request, including by sending two or more prompts to a generative AI service;
receive a final result obtained by sending the two or more prompts to the generative AI service; and
return the final result to the remote system in response to the API call.

2. The system of claim 1, wherein the API call is received at an API endpoint associated with the communication interface.

3. The system of claim 1, wherein the remote system comprises an application server and the API call is generated and sent by an application running on the application server.

4. The system of claim 1, wherein the prompt program is written in a scripting or other interpreted language.

5. The system of claim 4, wherein the prompt program is executed in one or more of a runtime, a virtual machine, and a container.

6. The system of claim 1, wherein the prompt program includes code to receive from the generative AI service a first response to a first prompt sent by the prompt program and use data comprising the first response to generate a second prompt.

7. The system of claim 6, wherein the second prompt causes the generative AI service to generate a query to an external system.

8. The system of claim 1, wherein the prompt program includes code to use data comprising a first response to a first prompt to send a query to the remote system.

9. The system of claim 1, wherein the prompt program includes code to use data comprising a first response to a first prompt to send a query to a third-party system.

10. The system of claim 1, wherein the prompt program includes two or more branches and the prompt program further includes code to receive from the generative AI service a first response to a first prompt sent by the prompt program and use data comprising the first response to select a branch from among the two or more branches along which to continue execution of the prompt program.

11. The system of claim 1, wherein the prompt program includes code to send two or more prompts concurrently to generative AI service.

12. The system of claim 1, wherein the generative AI service comprises a large language model.

13. The system of claim 1, wherein the prompt program comprises a first prompt program included in a plurality of prompt programs executable by the processor.

14. The system of claim 1, wherein code comprising the prompt program is included in or with the API call.

15. The system of claim 1, wherein an identifier associated with the prompt program the is included in or with the API call and the processor is further configured to map the identifier to the prompt program.

16. The system of claim 1, wherein the request includes one or more arguments operated on or otherwise used by the prompt program.

17. A method, comprising:
receiving from a remote system an API call comprising a request;
executing a server-side prompt program comprising or otherwise associated with one or both of the API call and the request, including by sending two or more prompts to a generative AI service;
receiving a final result obtained by sending the two or more prompts to the generative AI service; and
returning the final result to the remote system in response to the API call.

18. The method of claim 16, wherein the prompt program includes code to receive from the generative AI service a first response to a first prompt sent by the prompt program and use data comprising the first response to generate a second prompt.

19. The method of claim 17, wherein the second prompt causes the generative AI service to generate a query to an external system.

20. A computer program product embodied in a non-transitory computer readable medium and comprising computer instructions for:
receiving from a remote system an API call comprising a request;
executing a server-side prompt program comprising or otherwise associated with one or both of the API call and the request, including by sending two or more prompts to a generative AI service;
receiving a final result obtained by sending the two or more prompts to the generative AI service; and
returning the final result to the remote system in response to the API call.
